(19) United States
(12) Patent Application Publication
(10) Pub. No.: US 2004/0111411 A1
(43) Pub. Date: Jun. 10, 2004

(54) Method for representation of an internet object

(76) Inventor: Hartwig Koch, Hildesheim (DE)

Correspondence Address: KENYON & KENYON, ONE BROADWAY, NEW YORK, NY, 10004, US

(21) Appl. No.: 10/470,930

(22) PCT Filed: Dec. 19, 2001
(86) PCT No.: PCT/DE01/04794

(30) Foreign Application Priority Data
Jan. 31, 2001 (DE) 101 04 018.0

(51) Int. Cl. G06F 17/30

(52) U.S. Cl. 707/6

(57) ABSTRACT

A method of displaying an Internet object is used to allow only relevant data to be displayed from the source code of the Internet by filtering. This increases user convenience and operating convenience. Data which are not relevant can either simply disabled or hidden. The Internet objects can also be loaded using a digital wireless broadcast method such as DAB.

### BACKGROUND INFORMATION

The present invention is directed to a method of displaying an Internet object according to the preamble of the independent claim.

Web pages compiled in hypertext markup language (HTML) are displayed independently of the content and display options of the terminal. With the introduction of the page description language XML (extended markup language), which is a type of extension of HTML, it is possible at least to adapt the display to the terminal. Against that background, the object of the present invention is to create an improved display method for web pages.

### ADVANTAGES OF THE INVENTION

The method according to the present invention for displaying an Internet object having the features of the independent claim has the advantage over the related art that only relevant Internet objects or parts of Internet objects are displayed, thus permitting greater convenience in operation and reading and facilitating for the user the exchange of information and compression of the object data file. In particular, facilitating the exchange of information is a major advantage for the user, because he need no longer deal with an unnecessarily large volume of information which is of no interest to him in order to obtain the desired information.

Advantageous improvements of the method of displaying an Internet object characterized in the independent claim are possible through the measures characterized in the dependent claims.

It is particularly advantageous that such Internet objects or parts thereof that do not yield a match with the filter data are disabled. Alternatively, it is possible to hide this Internet object or parts thereof.

In addition, it is advantageous that a user or a locating device or a clock generates the filter data with which the source code of the Internet object is then filtered.

It is advantageous that the Internet objects may be loaded via a digital wireless broadcast method, e.g., DAB (Digital Audio Broadcasting), because such a wireless broadcast method has a large bandwidth and does not entail any cost to the customer for the transmission time. References in the Internet object, which may also include the Internet object itself, to other Internet objects which have not yet been loaded may then be disabled until these Internet objects are also loaded via the digital wireless broadcast system. Then as an alternative, these references may also be hidden or displayed as enabled.

Finally, it is also advantageous that a device for implementing this method is provided, having a loading device, in the case of a digital wireless broadcast method, a reception station for the Internet objects, an input device for the user, a processor for implementing the method according to the present invention, a memory, a display and a loudspeaker, the device then being connectable to a locating device and/or a clock. The device according to the present invention may also be designed as an electronic companion and thus utilize in particular the advantage of increased operating convenience because the operating options of a portable electronic companion are not as convenient as those of a desktop computer.

### DRAWING

Exemplary embodiments of the present invention are illustrated in the drawing and explained in greater detail in the following description.

FIG. 1 shows a block diagram of the device according to the present invention;

FIG. 2 shows a flow chart of the method according to the present invention;

FIG. 3 shows a second block diagram of the device according to the present invention; and

FIG. 4 shows an example of a filtered web page.

### BRIEF DESCRIPTION OF THE EXEMPLARY EMBODIMENT

When information is sought on the Internet, selecting the information is a time-consuming factor. Even the use of search engines often yields a great deal of information in which the user has no interest. He must then contend with the individual search results until he has found the desired information. In the case of portable devices in particular, i.e., electronic companions suitable for reception of web pages, one web page having a plurality of Internet objects, it may be extremely complex and time-consuming to make a selection, because here again, the operating options are not as convenient as those on a desktop computer. Therefore, according to the present invention, Internet objects are filtered with respect to their source code through filter data. Internet browsers available today provide options for viewing the source code of a web page and even acquiring it through a copy function.

Thus, according to the present invention, elements are sought in the source code according to their relevance for the user. The filter data defining relevance is generated locally and may be preselected either by the user or by a locating device, for example, so that geographically relevant data is displayed, or by a clock so that data relevant in time is displayed.

Display of relevant and non-relevant data may then be accomplished either by completely enabling the relevant data and totally eradicating the non-relevant data. In the case of non-relevant data, it is also possible to disable references, which are generally known as links, for example. An Internet object may then have a plurality of data, each being relevant or not. Therefore, it is possible according to the present invention for parts of Internet objects to also be enabled while other parts are not enabled.

Internet data may also be received via digital wireless broadcast methods, including DAB, but also DVB and DRM (Digital Radio Mondial) as well as satellite-supported digital radio, e.g., Sirius. These wireless broadcast methods have options for transmitting multimedia data such as web pages. Such multimedia data includes text, graphics, video and animation. Audio data may also be transmitted in this way. In addition to such wireless broadcast methods, mobile wireless methods, e.g., GSM or UMTS, are also suitable for transmitting web pages. These mobile wireless methods are to be used in particular as the narrow-band reverse channel when digital wireless broadcasting methods such as DAB are used as the forward channel. It is of course also possible to receive the data via a modem over a fixed network.

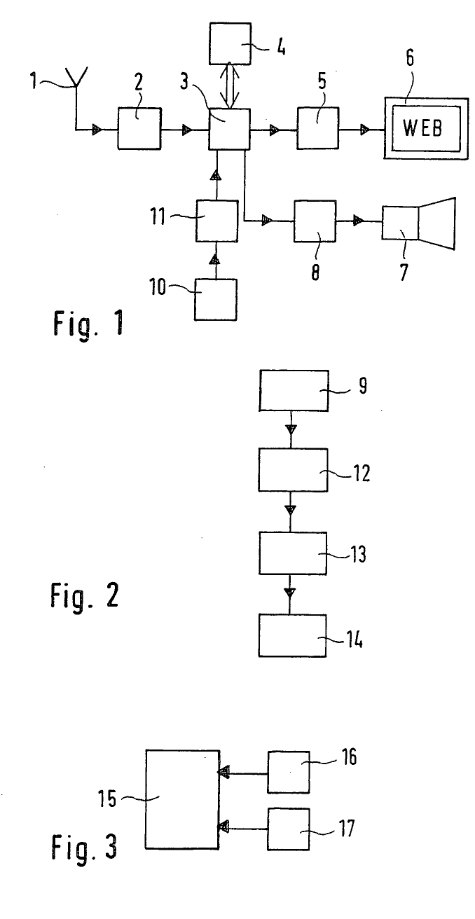

FIG. 1 shows the device according to the present invention as a block diagram, where the Internet objects are received via a digital wireless broadcasting method such as DAB. An antenna 1 receives the wireless signals, which are filtered by a high-frequency receiver 2, amplified and converted to an intermediate frequency, and digitizes them. The resulting digital datastream is then transmitted to a processor 3, which performs decoding and demodulation. Web pages thus determined are stored temporarily by processor 3 in a memory 4 connected to processor 3 via a data input/output. The Internet objects are then filtered by processor 3 according to the filter data also stored in memory 4, so that then only the relevant Internet objects are to be output by signal processing 5 and display 6 and/or audio preprocessing 8 and loudspeaker 7.

An input device 10 is also connected to processor 3 via signal processor 11. Filter data is directly inputtable by the user via input device 10 and web pages may of course also be selected in this way. The input device is usually a keyboard, optionally with a computer mouse or a trackball. However, voice control or even eye tracking control is also possible.

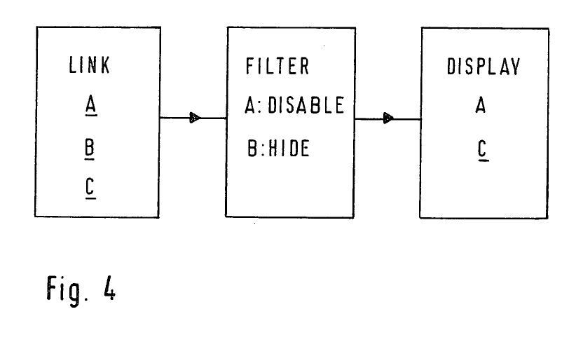

FIG. 2 shows a flow chart of the method according to the present invention. In method step 9, the Internet objects in the wireless signals are received with antenna 1 and high frequency receiver 2 and then transmitted as a digital datastream to processor 3, which stores them temporarily in memory 4 and then begins the filtering. In method step 12 processor 3 loads the filter data from memory 4. If necessary, additional filter data is generated in an updated form. According to FIG. 3, where the device according to the present invention is represented by block 15, this may be done by a locating device 16 and/or a clock 17, both of which transmit their data to the device according to the present invention. Filtering of the source code of the received Internet objects is then performed using this filter data, individual filter data also being selectable by the user. This is then performed in method step 13, where a correlation of the filter data with the data in the source code is sought.

For example, the term “weather” is sought in the source code, so that then only such Internet objects and/or elements of the source code having the term “weather” are displayed. It is then also possible for processor 3 to perform an ordered display of the Internet objects according to various terms. This may be done in such a way that, for example, first the Internet objects containing the term “weather” are displayed, and then the objects containing the term “stock market” are displayed, and finally objects containing the term “sports” are displayed. Then in method step 14 the corresponding Internet objects are displayed by display 6.

FIG. 4 shows another example of this filtering. References A, B, C, which are referred to as links, are present here in the web page received. The underlining symbolizes that these links are enabled. The filter then determines that link A is disabled and link B is hidden. This means that link C has resulted in a match with filter data. The right block shows the links which are now displayed. Link A is shown as disabled and therefore it is not underlined and link C is shown as enabled. Link B is not displayed because it is hidden.

Another possibility is to set off links or passages as parts of Internet objects in color if predetermined criteria are met. For example, a link for which first a relatively expensive mobile connection must be established is shown in red. This additional information helps the user make a selection.

What is claimed is:

1. A method of displaying an Internet object, the Internet object being transmitted along with its source code, wherein, before being displayed by a display device (6), filter data is generated; the source code together with the filter data are checked for consistency of elements of the source code with the filter data; and the Internet object is displayed as a function of this check.

2. The method as recited in claim 1, wherein the Internet object or parts of the Internet object that do not yield a match with the filter data are disabled.

3. The method as recited in claim 1 or 2, wherein the Internet object or parts of the Internet object that do not yield a match with the filter data are hidden.

4. The method as recited in one of the preceding claims, wherein a user and/or a locating device (16) and/or a clock (17) generate(s) the filter data.

5. The method as recited in one of the preceding claims, wherein the Internet objects are loaded by a digital wireless broadcast method.

6. The method as recited in claim 5, wherein references in the Internet object to other Internet objects, which must still be loaded via the digital wireless broadcast method, are disabled.

7. The method as recited in claim 5, wherein the references in the Internet object to other Internet objects, which must still be loaded via the digital wireless broadcast method, are hidden.

8. The method as recited in claim 5, wherein the references in the Internet object to other Internet objects, which must still be loaded via the digital wireless broadcast method, are displayed in enabled form.

9. A device for implementing the method as recited in one of claims 1 through 8, wherein the device has a loading device (1, 2) for the Internet objects, an input device (10), a processor (3), a memory (4), a display (6) and a loudspeaker (7).

10. The device as recited in claim 9, wherein the device is designed as an electronic companion.
